(19) United States
(12) Patent Application Publication
(10) Pub. No.: US 2010/0197866 A1
(43) Pub. Date: Aug. 5, 2010

(54) ALKOXYSILANE GROUP-BEARING LCST POLYMERS

(75) Inventors: Marc Entemann, Fellbach (DE); Matthias Schrod, Ergolding (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GMBH, Darmstadt (DE)

(21) Appl. No.: 12/063,370

(22) PCT Filed: Aug. 10, 2006
(86) PCT No.: PCT/EP2006/007934

§ 371 Date: Mar. 23, 2010

(30) Foreign Application Priority Data
Aug. 11, 2005 (DE) 10 2005 038 107.3

(51) Int. Cl. C08F 226/06; C08F 220/56; C08F 8/42

(52) U.S. Cl. 525/326.5

(57) ABSTRACT

The application describes LCST polymers containing terminal and/or pendant alkoxysilane groups —Si(OR¹)ₓR¹_{y} on the main chain, where R¹ stands for an alkyl radical having 1 to 6 carbon atoms, y can adopt the values 0, 1 and 2, and furthermore: x+y=3. The LCST polymers can be crosslinked via a condensation reaction of the alkoxysilane groups. This enables the production from the LCST polymers of coatings which adhere very strongly to surfaces. Coatings of this type are not contaminated by free-radical initiators, meaning that premature curing cannot be initiated on incorporation, for example, into powder coatings. The application furthermore describes processes for the preparation thereof and the use thereof for coating particles and non-particulate substrate surfaces.

The invention relates to LCST (lower critical solution temperature) polymers. This term is taken to mean polymers which are soluble in a liquid medium at a low temperature, but precipitate out of the liquid medium above a certain temperature (the LCST). LCST polymers have different chemical compositions. The best-known LCST polymers are polyalkylene oxide polymers, for example polyethylene oxide (PEO) or polypropylene oxide (PPO) polymers, but also (PEO)-(PPO) copolymers, in particular PEO-PPO-PEO block copolymers. Other LCST polymers are poly(N-isopropylacrylamide)ethyl(hydroxyethyl)cellulose derivatives, poly(N-vinylcaprolactam) derivatives and poly(methyl vinyl ether) derivatives.

The first-mentioned polymers are described, for example, in WO 01/60926 A1. This publication relates to a process for coating substrate surfaces (particle surfaces and nonparticulate substrate surfaces) with LCST polymers, in which an LCST polymer is dissolved in a solvent at a temperature below the LCST, this solution is mixed with the substrate surfaces to be coated, and the mixture obtained in this way is heated to above the LCST until the deposition of LCST polymers on the substrate surfaces begins. The deposited LCST polymer can be immobilised by providing it with functional groups which allow essentially irreversible adsorption on the substrate surface. The functional groups can be selected from acid groups, hydroxyl groups, amino groups, phosphate groups, mercaptan groups, siloxane groups or hydrophobic groups. Furthermore, the LCST polymers can be provided with functional groups which, after deposition of the LCST polymers on the particles, allow crosslinking of the LCST polymers in a crosslinking reaction. Functional groups of this type can be selected from carboxylic acid group derivatives, chloroformate groups, amino groups, isocyanate groups, oxirane groups and/or groups which can be crosslinked by means of free radicals, where the crosslinking reaction is initiated, inter alia, by changing the pH of the solution.

Free-radical crosslinking is less preferred than crosslinking by changing the pH. The examples indicate merely the sheathing of diverse pigment particles (TiO₂, Fe₂O₃, Cu phthalocyanine blue and also semiconductor wafers having a silicon dioxide surface) with PEO-PPO-PEO block copolymers. Fixing of the copolymers deposited on the substrate surfaces is not mentioned.

The use of LCST polymers for sheathing superparamagnetic particles is furthermore known from WO 97/45202. These particles comprise a core of a first polymer, an inner layer of a second polymer, which coats the core and in which a magnetic material is dispersed, and an outer layer of a third polymer, which coats the magnetic layer and is capable of reacting with at least one biological molecule, the second polymer at least being heat-sensitive and having an LCST of 15 to 65° C. The second polymer is preferably obtained by polymerising (1) a water-soluble acrylamide monomer, such as N-isopropylacrylamide (NIPAM), (2) at least one crosslinking agent, such as N,N-methylenebisacrylamide, and (3) at least one functional cationic and water-soluble monomer which is different from the monomer (1), for example the chloride of 2-aminoethyl methacrylate. A further preferred polymer is [poly-(N-isopropylacrylamide)] (PNIPAM).

“Patent Abstracts of Japan”, Vol. 009 No. 188 (C295) (1985) page 107=JP 60 058 237 A describes the encapsulation of inorganic particles. The aim is to prepare a stable particle dispersion. The inorganic particles are suspended in water and brought into contact with an aqueous solution of the LCST polymer below the LCST. If the temperature of the resultant system is raised, a layer of the LCST polymer is deposited on the inorganic particles. A monomer which can be polymerised by means of free radicals, an initiator and, if desired, an emulsifier are added to the resultant particle suspension, and an emulsion polymerisation is carried out, giving encapsulated particles. Furthermore, the polymerised monomer layer arises as outer layer, so that the function of the LCST polymer layer consists only in simplifying the penetration of monomer radicals.

The polymerisable monomer is thus reacted with the LCST polymer which is already located on the particles, or the water-soluble polymer is sheathed with a layer of the polymer obtained from the polymerisable monomer. This process has the disadvantage that the grafting-on only takes place at the active centres of the previously deposited LCST polymer, meaning that the sheathing is non-uniform and heterogeneous and does not represent a complete barrier.

In addition, a monomer must be added to the dispersion of the coated particles in order to initiate crosslinking. In the majority of cases, the monomer is not consumed completely, meaning that a certain proportion of the monomer remains in the crosslinked structure. Later emission of the “dissolved” monomers from the polymer is undesired since the monomer is harmful to health.

Furthermore, disadvantages are to be expected in the surface-coating system as a result of the detachment of the copolymerised emulsifier if the pigment comes into contact with solvents.

WO 92/20441 describes a process for the production of encapsulated particles, where the particles contain a core surrounded by a coacervate coating. In this process, an aqueous solution of an LCST polymer at a temperature of reversible insolubilisation (TRI) of T1 is brought into contact with a dispersion of the particles at a temperature of T2 which is lower than T1, after which the dispersion is heated to a temperature above T1, causing the LCST polymer to be deposited around the particles as a coacervate. An agent for lowering the TRI is then added to the solution, causing the TRI of the LCST polymer in the solution to be lowered to a temperature T3 which is lower than T1, after which either the dispersion is cooled to a temperature between T3 and T1 and held at this temperature or the particles are separated from the dispersion at a temperature greater than T3. Agents which can be used for lowering the TRI are electrolytes and water-miscible organic liquids in which the LCST polymer is insoluble.

The LCST polymers used are preferably synthetic polymers (homopolymers or copolymers) with hydrophilic monomers. Suitable LCST monomers are acrylic or vinyl compounds. If LCST copolymers are used, the comonomer is usually hydrophilic and may be nonionic or ionic. Suitable nonionic monomers are certain acrylic or vinyl compounds. Anionic or cationic monomers are, for example, acrylic acid derivatives or dialkylaminoalkyl acrylates. However, these compounds are already saturated at the ends, meaning that crosslinking reactions are no longer possible.

LCST polymers are also known, for example, from EP 0 629 649 A1. They are employed as rheofluidising additives and antisettling agents in diaphragm wall construction, for wells in the oil industry, and as hydraulic fluids and lubricants.

EP 0 718 327 A2 discloses universally compatible pigment dispersants which are composed of methyl methacrylate and an acrylate or methacrylate. However, these polymers serve only for the dispersion of pigments, but not for the sheathing of pigments.

DE 198 02 233 A1 describes gels having thermotropic properties which are used, for example, for glazing systems in order to achieve darkening as a function of insolation. The gels comprise an LCST polymer which is built up from 60-99.9% by weight of ethylenically unsaturated lactams or vinyl ethers (monomer A), 0-20% by weight of ethylenically unsaturated compounds having a crosslinking action (monomer B), 0.1-30% by weight of monomers containing at least one acid or acid anhydride group (monomer C) and 0-20% by weight of further monomers D. The LCST polymer preferably comprises only monomers A and C, meaning that the LCST polymer is not crosslinked on irradiation. For the preparation of the gel, a solution is prepared from the LCST polymer and a monomer (b) which can be polymerised by means of free radicals, and the solution is irradiated with high-energy light. During this irradiation, monomer (b) forms a three-dimensional network, i.e. a gel, which is insoluble or sparingly soluble in the solvent or solvent mixture selected. The LCST polymer is incorporated into the network formed from monomer (b), giving a thermotropic gel which is crosslinked with very wide meshes. The gel must be capable of being applied between the glass plates and must fill the interspace between the glass plates.

A similar polymer system is described in DE 197 19 224 A1. A layer structure is described in which a thermotropic polymer system is arranged between an inner transparent glass sheet and an outer transparent glass sheet, i.e. one which is exposed to natural sunlight. The thermotropic polymer system is protected against UV light exposure in the long term by means of a UV protection layer. Here too, the thermotropic polymer system consists of a gel which is crosslinked with wide meshes.

DE 197 00 064 A1 describes gels having thermotropic properties which are obtained by irradiating a mixture which comprises an uncrosslinked polymer, monomers which can be polymerised by means of free radicals, water or an organic solvent or mixtures thereof, and at least one specific photoinitiator. Here too, an LCST polymer is incorporated into a wide-meshed gel structure which is prepared from the monomers which can be polymerised by means of free radicals. The gel is intended to be used as a thermotropic layer in glazing systems.

DE 196 01 085 A1 describes gels having thermotropic properties which are likewise intended to be used for glazing systems. The gels are obtained by irradiation of a mixture comprising (a) an uncrosslinked polymer in amounts below 5% by weight, based on the sum of (a), (b) and (c), (b) monomers which can be polymerised by means of free radicals, and (c) water or an organic solvent or mixtures thereof. Here too, the LCST polymer is incorporated into a wide-meshed network formed from the monomer which can be polymerised by means of free radicals.

DE 196 01 084 A1 describes gels for thermotropic layers which are obtained by irradiation of a mixture with high-energy light. The mixture comprises an uncrosslinked polymer having a number-average molecular weight Mₙ of 1000 to 30,000 g/mol (LCST polymer), monomers which can be polymerised by means of free radicals, and water or an organic solvent or mixtures thereof. These gels are likewise intended to be used as a thermotropic layer in glazing systems. Here too, a gel is formed into the wide-meshed structure of which the LCST polymer is incorporated.

In the above-described thermotropic gels for glazing systems, the LCST polymer is said also to retain its thermotropic properties in the gel, enabling it to be precipitated and dissolved repeatedly in order to allow as many darkening/|lightening cycles as possible to be passed through. A gel of this type is not suitable for the formation of coatings.

A further system of this type is described in DE 44 14 088 A1. These gels likewise comprise an LCST polymer which is incorporated into a gel which is produced by polymerisation of monomers which can be polymerised by means of free radicals in a suitable solvent, such as water or an organic solvent.

EP 1 072 667 B1 describes a process by means of which LCST polymers can be immobilised on a substrate, such as a glass plate. To this end, the substrate, on the surface of which OH groups are arranged, is firstly reacted with a coupling reagent which on the one hand contains reactive groups which are able to react with the OH groups on the surface of the substrate with formation of a covalent bond and on the other hand contains reactive groups which are able to react with the LCST polymer with formation of a covalent bond. Suitable coupling reagents are, for example, chlorosilanes which contain a chloromethyl group, such as p-chloromethylphenyltrichlorosilane. The LCST polymer is then applied to the surface coated with the coupling reagent, enabling suitable groups of the LCST polymer, for example a terminal NH₂ group, to react with the remaining reactive group of the coupling reagent with formation of a covalent bond. The LCST properties of the LCST polymers are retained even after bonding of the polymer to the substrate surface.

U.S. Pat. No. 6,270,903 B1 describes a glass substrate to which a thin layer of an LCST polymer has been applied. To this end, firstly a coupling reagent is applied to the glass substrate. The coupling reagent contains at one end a halosilicon or alkoxysilane group, which reacts with OH groups arranged on the glass surface. At the opposite end, the coupling reagent contains a group from which free radicals are produced. A suitable group is the thiocarbamate group, from which free radicals can be produced by UV radiation. N-isopropylacrylamide (NIPAAm) and a crosslinking reagent which are dissolved in a polar solvent are applied to the modified glass surface. The crosslinking reagent used can be organic molecules which contain an acrylamide group and at least two double bonds. An example of a crosslinking reagent is N,N′-methylenebisacrylamide. Irradiation with UV light produces free radicals, which then react with the crosslinking reagent and the NIPAAm, producing a thin layer of the LCST polymer. According to another embodiment, vinyl groups are provided on the glass surface by reacting a vinylsilane with hydroxyl groups on the glass surface. The NIPAAm and the crosslinking reagent are then again polymerised onto the modified glass surface.

WO 2004/052946 discloses LCST polymers which are obtainable by free-radical co- or terpolymerisation in aqueous or alcoholic solution, where the polymer obtained by copolymerisation is derivatised by means of a derivatisation agent which contains at least one group which is able to react with a group of a recurring unit emanating from the comonomer with formation of a covalent bond, and at least one polymerisable double bond. The LCST polymers described in WO 2004/052946 carry pendant unsaturated groups on the main chain which can be polymerised by means of free radicals. These LCST polymers can be applied to particles or substrate surfaces by firstly preparing a solution of the LCST polymer in a suitable solvent at a temperature below the LCST, introducing the particles or substrate surface into the solution and precipitating the LCST polymers on the particles or substrate surface by raising the temperature to above the LCST. Since the LCST polymers still contain polymerisable groups, the LCST polymer can then be crosslinked by addition of a suitable free-radical initiator and thus permanently fixed to the particle or substrate surface.

Although very good results have been achieved with the LCST polymers described in WO 2004/052946, difficulties may occur in specific applications. If pigments coated with the LCST polymers described in WO 2004/052946 are employed in powder coatings, premature curing of the coating is observed in a few cases. Powder coatings are taken to mean thermoplastic or thermosetting coating materials which are applied in powder form to predominantly metallic substrates. The coated substrates are heated, so that the powder coating melts and a polymerisation reaction simultaneously occurs, by means of which the powder coating is crosslinked and thus permanently fixed to the substrate surface.

A powder coating is prepared in a plurality of process steps. Firstly, the raw materials pre-comminuted to granule size are mixed. This mixture is then melted in an extruder at temperatures in the range from about 80 to 120° C. and mixed intimately under the action of high shear. The melt-homogenised mixture generally leaves the extruder with a temperature in the region of about 100° C. In order to prevent premature curing of the mixture, the latter is cooled as rapidly as possible. The extrudate is cut to a suitable size and then ground to give a powder coating.

On use of pigments which have been coated with LCST polymers described in WO 2004/052946, premature partial polymerisation of the powder coating during melt homogenisation in the extruder has been observed in exceptional cases. This is attributed to residues of the free-radical initiator remaining in the polymer layer on the pigment after crosslinking of the LCST polymer. In this way, some of the groups provided for crosslinking of the powder coating are lost, meaning that the quality of the coating film drops. In very unfavourable cases, the powder coating could even already polymerise in the extruder, blocking the latter. The polymerised powder coating can then only be removed from the extruder again with considerable effort.

The invention had the object of providing LCST polymers which no longer detach from a substrate surface on cooling, but instead remain strongly bonded thereto. After application to the substrate surface, the LCST polymers should not be able to initiate any further side reaction, in particular should not cause premature polymerisation of a matrix under high thermal load.

This object is achieved in accordance with the invention by LCST polymers having the features of Patent Claim 1. Advantageous embodiments of the LCST polymers according to the invention are the subject-matter of the dependent claims.

The LCST polymers according to the invention contain alkoxysilane groups, such as, for example, terminal or pendant —Si(OR¹)ₓR¹_{y}, on the polymer main chain, where R¹ stands for an alkyl radical having 1 to 6 carbon atoms, the sum of x and y gives the value 3, and y can adopt the values 0, 1 and 2. The radicals R¹ may be identical or different here. The LCST polymers according to the invention can thus contain monoalkoxysilane groups, dialkoxysilane groups or trialkoxysilane groups, where trialkoxysilane groups are particularly preferred. R¹ is particularly preferably an ethyl group.

The alkoxysilane groups provided in the LCST polymer according to the invention can undergo a condensation reaction, for example in the presence of water, where the LCST polymer chains are bonded via an Si—O—Si group with elimination of the corresponding alcohol. On application to, for example, the surface of a pigment particle or a substrate surface, the usual procedure, as described, for example, in WO 2004/052946, is initially followed. The polymer is dissolved in a suitable solvent, usually an aqueous or aqueous/alcoholic solvent, below the LCST, and the surface to be coated is wetted with this solution. The temperature is then raised to above the LCST, so that the LCST polymer is precipitated onto the surface of the particle or substrate. In the presence of the solvent, the alkoxysilane groups are hydrolysed and then react further with crosslinking of the polymers. Since the crosslinking proceeds via a condensation reaction, it is not necessary to add a free-radical initiator. Consequently, it is likewise not possible for any residues of free-radical initiator which can result in undesired side reactions, for example during preparation of a powder coating, to remain in the coating of the LCST polymers. If pigments which have been coated with the LCST polymer according to the invention are used for the preparation of a powder coating, higher quality of the coating can therefore be obtained, since premature polymerisation or crosslinking can be suppressed during preparation of the powder coating during melt homogenisation, and virtually all the corresponding groups in the powder coating are available for later thermal curing.

The LCST polymers according to the invention are themselves colourless, meaning that, in the case of coating of a pigment, they do not hide or falsify the colour of the latter, but instead allow it to appear brightly. Since the crosslinking takes place between the individual polymer chains, reactive groups for fixing of the polymer do not necessarily have to be provided on the surface of the pigment. Nevertheless, excellent adhesion of the coating produced from the LCST polymer is ensured on the surface, for example, of a pigment particle.

If, however, suitable reactive groups, such as, for example, hydroxyl groups, are provided on the particle or substrate surface, it can be expected that direct chemical bonds between polymer and particle or substrate surface are formed via silane groups. This direct anchoring of the polymers on the particle or substrate surfaces means that the polymer hardly detaches at all from the substrate, even under drastic conditions, for example on heating in a suitable solvent.

The LCST polymers according to the invention can be obtained by modifying LCST polymers known per se by the introduction of alkoxysilane groups. The introduction of these radicals does not significantly influence the properties of these polymers, in particular their LCST properties. If the LCST polymer already contains groups which allow modification, for example a hydroxyl group, the modification can take place by reacting the LCST polymer with an appropriate derivatisation agent which contains a reactive group corresponding to the group on the LCST polymer and an alkoxysilane group. If a reactive group of this type is not yet provided on the LCST polymer, the LCST polymer serving as starting point can, for example, be correspondingly modified by additionally introducing, during preparation thereof, a corresponding monomer which provides a corresponding reactive group for later introduction of the alkoxysilane group or already contains an alkoxysilane group.

The number of alkoxysilane groups provided in the LCST polymer depends on the desired degree of crosslinking. It may already be sufficient to introduce terminal alkoxysilane groups into the LCST polymer. For a higher degree of crosslinking, the number of alkoxysilane groups can be increased, in which case it must be ensured that the LCST properties of the modified polymer are retained. The number of alkoxysilane groups in the LCST polymer can be increased by arranging them in pendant positions on the polymer main chain. The proportion of alkoxysilane groups, based on the total number of recurring units of the LCST polymer, is advantageously between 0.1 and 55 mol %, particularly preferably between 1 and 30 mol %, especially preferably between 5 and 15 mol %.

The LCST polymers according to the invention are preferably prepared by free-radical polymerisation of ethylenically unsaturated monomers. The LCST polymers according to the invention therefore preferably comprise, as backbone, a chain of carbon atoms. The alkoxysilane groups are then, in accordance with the invention, arranged terminally or in pendant positions to this carbon chain.

In accordance with a particularly preferred embodiment, the LCST polymers according to the invention are obtainable by polymerisation of:
A. about 45.0 to 99.9 mol % of at least one monomer or macromonomer containing the structural unit:
   a. N,N-dialkylacrylamide

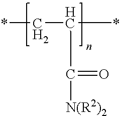

in which n denotes 1 to 10,000 and R² (identical to or different from one another) denotes hydrogen or alkyl groups having 1 to 5 carbon atoms, where the radicals R² may also form a ring together with the nitrogen atom;
b. N-vinylcaprolactam

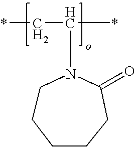

in which o denotes 1 to 10,000;
c. N-vinylpiperidone

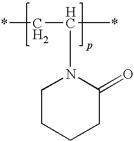

in which p denotes 1 to 10,000;
d. N-vinylpyrrolidone

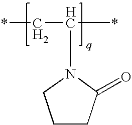

in which q denotes 1 to 10,000;
e. methyl vinyl ether

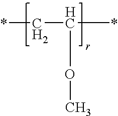

in which r denotes 1 to 10,000;
f. and/or N-vinylalkylamide

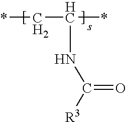

in which s denotes 1 to 10,000 and R³ denotes an (iso)alkyl group having 1 to 5 carbon atoms or a cyclopentyl group;
B. 0 to 55.0 mol % of at least one comonomer from the group of:
   a. hydroxyalkyl acrylates or methacrylates in which the hydroxyalkyl group contains 1 to 5 carbon atoms;
   b. glycidyl(meth)acrylate;
   c. allyl glycidyl ether;
   d. α,α-dimethyl-meta-isopropenylbenzyl isocyanate;
   e. vinyl isocyanate;
   f. isocyanatoethyl(meth)acrylate and/or isocyanatopropyl(meth)acrylate;
   g. propenyl isocyanate;
   h. primary and secondary acrylamides and methacrylamides;
   i. hydroxy- and amino-terminated polyalkylene oxide(meth)acrylates, allyl and vinyl compounds;
C. 0 to 55.0 mol % of at least one comonomer of the formula I:

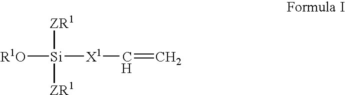

in which:
R¹, each independently, denotes an alkyl radical having 1 to 6 carbon atoms;
X¹ denotes a single bond or an alkylene radical having 1 to 6 carbon atoms, a phenylene radical, —(O—(CH₂CHY))ₘ—, where m=1 to 6 and Y═H, CH₃;
Z, each independently, denotes an oxygen atom or a single bond;
where comonomers (A), (B) and (C) add up to 100%, and where furthermore, if the LCST polymer contains comonomers B, the polymer obtained by copolymerisation of the monomers or macromonomers (A), (B) and optionally (C) is derivatised by means of a derivatisation agent which contains at least one group which is able to react with a group of a recurring unit emanating from the comonomer (B) with formation of a covalent bond, and at least one alkoxysilane group —Si(OR¹)ₓR¹_{y}, where R¹ stands for an alkyl radical having 1 to 6 carbon atoms, y can adopt the values 0, 1 and 2, and furthermore x+y=3.

“Macromonomers” are taken to mean polymers which can be polymerised. These macromonomers thus also contain, for example, a reactive polymerisable double bond. The monomers or macromonomers from group A can be employed, for example, as ethylenically unsaturated monomers, i.e., for example, as monomeric N,N-dialkylacrylamide, N-vinylcaprolactam, N-vinylpiperidone, N-vinylpyrrolidone, methyl vinyl ether and/or N-vinylalkylamide. However, it is also possible firstly to pre-polymerise these monomers to give larger macromonomers and only then to convert them into the LCST polymer according to the invention with addition of moieties from constituents B and/or C.

In the preparation of the LCST polymers according to the invention, a polymer which already has LCST properties is firstly prepared from the monomers or macromonomers (A), (B) and/or (C). This reaction is generally carried out in solution. Depending on the solubility of the polymer, turbidity may arise during the reaction. However, this does not affect the structure or properties of the polymer. For the preparation of this polymer, a suitable solvent is selected in which both the monomers or macromonomers (A), (B) and/or (C) and the polymer are soluble, so that the reaction proceeds substantially homogeneously. Suitable solvents are, for example, water or alcohols, such as methanol, ethanol or isopropanol, or mixtures of these solvents. Aliphatic or aromatic solvents can also be used. Aromatic solvents are preferred owing to their better dissolution properties. Suitable aromatic solvents are, for example, toluene or the xylenes. The use of aliphatic or aromatic solvents is particularly preferred if the polymer contains reactive groups for the derivatisation which are able to react with water or alcohols. It is also possible to use solvent mixtures here. Besides the said solvents, it is also possible to use other solvents.

The polymer prepared in the first step may contain only one monomer from each of groups (A), (B) and/or (C) indicated above. However, it is also possible for the polymer to contain two or more monomers from the each of groups (A), (B) and/or (C) indicated above. Accordingly, the polymer is obtained by co- or terpolymerisation. Polymerisations with more than three different monomers can be carried out where appropriate.

The monomers included in group (A) have a different polarity, meaning that it is possible to influence the LCST of the LCST polymer through the ratio of the individual monomers (or macromonomers). Thus, monomer ((A, d); N-vinylpyrrolidone) has relatively polar properties and results in an increase in the LCST, whereas monomer ((A, b); N-vinylcaprolactam) has significantly more nonpolar properties, i.e. results in a lower LCST of the LCST polymer. Preference is given to the use of monomer ((A, d); N-vinylpyrrolidone) together with another monomer from group (A), particularly preferably in combination with one or both of monomers ((A, b); N-vinylcaprolactam) and ((A, c); N-vinylpiperidone) and especially preferably in combination with monomer ((A, b); N-vinylcaprolactam). The proportion of monomer ((A, d); N-vinylpyrrolidone) in the monomers from group (A) is preferably selected to be less than 80 mol %, in particular less than 70 mol %, and particularly preferably less than 60 mol %.

The monomers from group (B) introduce groups which allow subsequent derivatisation of the polymer. Besides a polymerisable double bond, the monomers from group (B) therefore contain at least one reactive group which on the one hand does not adversely affect the polymerisation reaction and on the other hand remains in the polymer in order to facilitate reaction with a derivatisation agent. The polarity of the monomers from group (B) furthermore enables the LCST of the LCST polymer to be modified.

The monomers from group (C) already contain an alkoxysilane group. In order to simplify the synthesis, the monomers from groups (B) and (C) are therefore preferably selected alternatively. In the case of polymers which contain only monomers from groups (A) and (C), derivatisation of the polymer in order to introduce alkoxysilane groups is consequently no longer necessary.

If the polymer is prepared with participation by monomers from group (B), derivatisation of the polymer, through which pendant alkoxysilane groups are introduced into the polymer, is carried out in a subsequent synthesis step. The compounds by means of which the polymer is derivatised contain on the one hand an alkoxysilane group and on the other hand a reactive group which allows linking to the backbone of the polymer. The linking here takes place via the reactive group introduced through the monomers B. The introduction of these compounds does not significantly affect the LCST properties of the LCST polymer. The reactive group of the derivatisation agent is selected in accordance with the group introduced into the polymer with the monomer from group (B). If, for example, an epoxy group or an isocyanate group is provided on the polymer, the derivatisation agent preferably contains a hydroxyl group, a carboxyl group or an amino group. The derivatisation is therefore preferably carried out using unsaturated alcohols, carboxylic acids or amines. If the reactive group introduced into the polymer with the monomer from group (B) was a hydroxyl group, the derivatisation agent correspondingly contains, for example, an epoxy group or an isocyanate group.

After any derivatisation, the LCST polymer contains pendant alkoxysilane groups —Si(OR¹)ₓR¹_{y}, where R¹ in each case independently stands for an alkyl radical having 1 to 6 carbon atoms, the sum of x and y gives the value 3, and y can adopt the values 0, 1 and 2. The advantage of the LCST polymers according to the invention thus also lies in the fact that, after deposition on a surface, they can be crosslinked further, enabling a very high degree of crosslinking to be achieved.

The derivatisation agent via which an alkoxysilane group can be introduced into the polymer by reaction with a corresponding group on recurring units from the comonomer from group (B) preferably has a structure of the formula II:

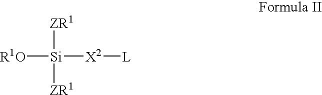

in which:
R¹, each independently, denotes an alkyl radical having 1 to 6 carbon atoms;
X² denotes an alkylene radical having 1 to 6 carbon atoms, a phenylene radical, —(O—(CH₂CHY))ₘ—, where m=1 to 6 and Y═H, CH₃;
Z, each independently, denotes an oxygen atom or a single bond;
L denotes —OH, —SH, —N═C═O, —N═C═S,

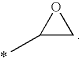

In accordance with a preferred embodiment, the introduction of the pendant alkoxysilane group can be carried out by selecting comonomer (B) from the group (a), (h) and (i) and selecting L in the derivatisation agent of the formula II from —N═C═O, —N═C═S,

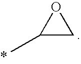

Illustrative derivatisation agents are isocyanatopropyltriethoxysilane and 3-(glycidoxypropyl)methylmethoxysilane.

In accordance with a further embodiment, comonomer (B) is selected from the group (b) to (g), and L in the derivatisation agent of the formula II is selected from —OH, —NH₂ and —SH.

Suitable derivatisation agents are, for example, N-hydroxyethyl-N-methylaminopropyltrimethoxysilane, hydroxyethyltriethoxysilane and hydroxymethyltriethoxysilane.

For the LCST polymers, it is not possible to give precise formulae since the monomers are generally arranged in a random distribution in the polymer chain. However, the polymer chain may also be composed of blocks of the same monomers.

Surprisingly, it has been found that, after the polymerisation and any derivatisation of comonomers (B) (a) to (B) (i), the polymers according to the invention can be irreversibly immobilised on a substrate surface. A large number of alkoxysilane groups are available in the molecule for immobilisation of the LCST polymers according to the invention. The presence of numerous alkoxysilane groups means that the crosslinking density becomes very high. A further point is that, due to the tighter crosslinking (high crosslinking density), swelling of the polymer immobilised on the pigment in (aqueous) solvents is significantly lower. This is a major advantage on incorporation of the coated pigments into surface coating materials since paint defects, such as blistering and swelling, occur to a lesser extent.

The polymers according to the invention usually have an LCST in the range from 5 to 80° C., which is dependent, inter alia, on the following factors:
molar ratio of the hydrophobic and hydrophilic fractions of the LCST polymer,
molecular weight of the LCST polymer,
number of polymerisable and ionisable groups,
concentration of the polymer,
pH and ionic strength of the medium.

The LCST polymers consist of polar and nonpolar or hydrophilic and hydrophobic segments. The LCST can be customised by variation of these individual segments and also the overall chain length.

After the polymerisation and derivatisation, the LCST polymers according to the invention can be employed as dispersants fixed to the substrate surfaces. In this way, the cost of the expensive step of pigment dispersion, inter alia, is reduced, since the pigment carries its dispersant with it. Furthermore, the pigments coated in this way form agglomerates to a lesser extent than do untreated pigments, meaning that the dispersal is easier to carry out, resulting in an additional cost reduction.

Dispersants are surface-active substances which simplify dispersion of a pulverulent substance, for example a pigment or filler, in a liquid dispersion medium by lowering the surface tension between the two components. As a result, they simplify mechanical break-up of the secondary particles, which are present in the form of agglomerates, into primary particles during pigment grinding. Furthermore, they protect the primary particles formed against reagglomeration or flocculation by complete wetting and formation of a protective colloid sheath or an electrochemical double layer.

Since the LCST polymers according to the invention are transparent or translucent in visible light, they are able to form a complete sheath around particles without affecting the colour of the particles themselves. Furthermore, pigments coated in this way exhibit very high colour strength in surface coatings since, owing to the LCST polymer coating, they do not form agglomerates.

The LCST polymers according to the invention can be prepared by free-radical polymerisation and optionally subsequent derivatisation. About 45.0 to 99.9 mol %, preferably about 75 to 99 mol %, of at least one monomer or oligomer from group (A) are employed here with 0 to 55.0 mol %, preferably about 0.1 to 30 mol %, particularly preferably about 1 to 25 mol %, of comonomer (B) and/or comonomer (C). The polymerisation is preferably carried out in solution.

It is also possible here to use mixtures of monomers (A), comonomers (B) and/or comonomers (C). The copolymers according to the invention can be prepared by free-radical polymerisation, preferably in aqueous or alcoholic solution. Low-molecular-weight alcohols (C₁ to C₅) are preferred here since they can easily be stripped off. If the comonomers from group (B) contain reactive groups which are able to react with alcohols or water, for example an epoxy group or an isocyanate group, the solvents used may also be aliphatic or aromatic hydrocarbons, with aromatic hydrocarbons being preferred. Suitable aromatic solvents are, for example, toluene or xylene. The polymerisation takes place in the presence of compounds which form free radicals, the polymerisation initiators, such as organic peroxide or azo compounds or inorganic peroxide compounds. In order to modify the molecular weight of the resultant copolymer, suitable polymerisation regulators, such as mercaptans, organic halogen compounds or aldehydes, are added. The polymerisation is generally carried out at temperatures of 50 to 200° C., preferably at temperatures of 80 to 140° C.

The LCST polymers according to the invention can be used for coating particles and non-particulate substrate surfaces. To this end, the LCST polymers are dissolved in a liquid medium below the LCST. The solution is brought into contact with the particles or non-particulate substrate surfaces, and the temperature is raised to above the LCST, so that the LCST polymers precipitate on the surface of the particles or substrate. The coating produced in this way is then fixed by polycondensing the polymers on the surface of the particles or on the non-particulate substrate surfaces via the alkoxysilane groups —Si(OR¹)ₓR¹_{y} at this or a higher temperature.

For the polycondensation, a catalyst is preferably added in order to accelerate the reaction of the alkoxysilane groups.

Suitable catalysts are, for example, protic acids, such as hydrochloric acid or acetic acid, transition-metal ions and particularly preferably dibutyltin acetate.

The particles which are suitable in accordance with the invention include pigments, fillers and nanoparticles. Pigments are pulverulent or flake-form colorants which, in contrast to dyes, are insoluble in the ambient medium (DIN 55943: 1993-11, DIN:EN 971-1: 1996-09). Pigments influence or determine the coloration and, for reasons of cost, are employed in the smallest possible amounts. Owing to interaction forces, the pigment particles may agglomerate, particularly during incorporation into the matrix material. This results, for example, in quality impairment in the resultant surface coating due, inter alia, to deficient colour strength, sedimentation or phase separation.

Preferred pigments are titanium dioxide, iron oxide, zinc oxide, carbon black, Cu phthalocyanine pigments, organic pigments, flake-form pigments, such as mica (optionally with oxidic and metallic coatings) or aluminium. Fillers which can be used are, for example, barium sulfate and talc. Nanoparticles which can be used are iron oxide, titanium dioxide and silicon dioxide particles and also nanoclays. Nanoclays consist, for example, of montmorillonite, bentonite, synthetic hectorite or hydrotalcite. They have a size of less than 1 μm along their longest dimension. They preferably have a length of several 100 nm and a thickness of less than 10 nm. Nanoclays have very high aspect ratios of up to 1000. The particles also include microfibres, such as glass, carbon, textile and polymer fibres.

The substrate surfaces may also be non-particulate surfaces, for example of glass, metal and semiconductors. Particularly preferred surfaces are silicon dioxide wafers used in the semiconductor industry.

The LCST polymers according to the invention are preferably brought into contact with the particles or non-particulate substrate surfaces in a liquid medium (for example in an aqueous or organic medium) below the LCST, after which the temperature is raised to above the LCST, and the polymers are crosslinked on the surface of the particles or on the non-particulate substrate surfaces via the alkoxysilane groups at this or a higher temperature.

The invention furthermore relates to particles or non-particulate substrate surfaces coated with the polymerised LCST polymer.

The invention is explained in a non-restrictive manner by the following examples and with reference to the attached figures, in which:

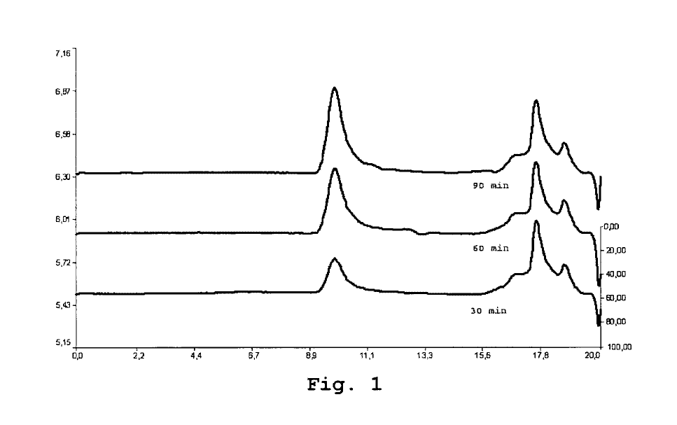

FIG. 1 shows a size exclusion chromatogram of a comparative sample in which a pigment coated in accordance with WO 2004/052946 was heated in methyl methacrylate;

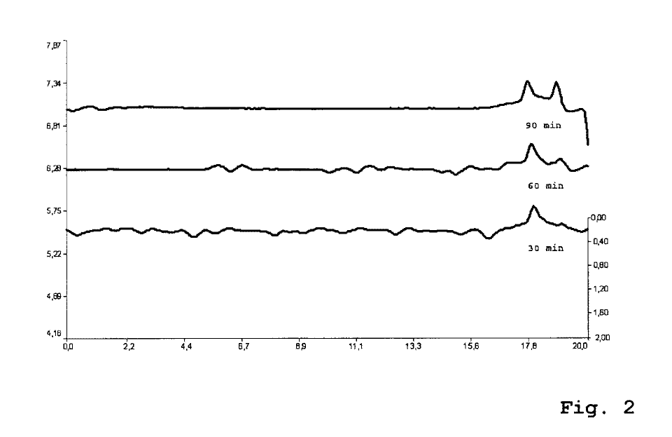

FIG. 2 shows a size exclusion chromatogram of a sample in which a pigment coated in accordance with the invention was heated in methyl methacrylate.

### EXAMPLE 1

### Copolymer of N-vinylcaprolactam and hydroxyethyl methacrylate, modified with 3-isocyanatopropyltriethoxysilane

263.89 g of N-vinylcaprolactam, 12.99 g of hydroxyethyl methacrylate and 8 g of dodecyl mercaptan are dissolved in 500 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. The copolymer is modified by reaction with 24.68 g of 3-isocyanatopropyltriethoxysilane with heating at 80° C. for 2 h. For isolation of the copolymer, the solvent is stripped off in vacuo, and the residue is freeze-dried. The resultant product has an LCST of about 25° C.

### EXAMPLE 2

### Copolymer of N-vinylcaprolactam and triethoxyvinylsilane

263.89 g of N-vinylcaprolactam, 18.99 g of triethoxyvinylsilane and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. For isolation of the copolymer, the solvent is stripped off in vacuo, and the residue is freeze-dried. The resultant product has an LCST of about 22° C.

### EXAMPLE 3

### Copolymer of N,N-diethylacrylamide and triethoxyvinylsilane

263.89 g of N,N-diethylacrylamide, 20.78 g of triethoxyvinylsilane and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. For isolation of the copolymer, the solvent is stripped off in vacuo, and the residue is freeze-dried. The resultant product has an LCST of about 12° C.

### EXAMPLE 4

### Copolymer of methyl vinyl ether and triethoxyvinylsilane

263.89 g of methyl vinyl ether, 45.51 g of triethoxyvinylsilane and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. For isolation of the copolymer, the solvent is stripped off in vacuo, and the residue is freeze-dried. The resultant product has an LCST of about 7° C.

### EXAMPLE 5

### Copolymer of N-vinyl-n-butyramide and triethoxyvinylsilane

263.89 g of N-vinyl-n-butyramide, 23.36 g of triethoxyvinylsilane and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. For isolation of the copolymer, the solvent is stripped off in vacuo, and the residue is freeze-dried. The resultant product has an LCST of about 12° C.

### EXAMPLE 6

### Copolymer of N,N-diethylacrylamide and methacrylic acid and subsequent modification with (3-glycidoxypropyl)trimethoxysilane

263.89 g of N,N-diethylacrylamide, 7.7 g of methacrylic acid and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. The copolymer is modified by reaction of the copolymer with 25.81 g of (3-glycidoxypropyl)trimethoxysilane at about 80° C. for a further five hours. The epoxide can also be added in portions or continuously during the reaction. For isolation of the copolymer, the solvent is stripped off in vacuo, and the residue is freeze-dried. The resultant product has an LCST of about 11° C.

### EXAMPLE 7

### Copolymer of N,N-diethylacrylamide and α,α-dimethyl-meta-isopropenylbenzyl isocyanate and subsequent modification with hydroxymethyltriethoxysilane

263.89 g of N,N-diethylacrylamide, 18.05 g of α,α-dimethyl-meta-isopropenylbenzyl isocyanate and 2 g of dodecyl mercaptan are dissolved in 300 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h.

The copolymer is modified by reaction of the copolymer with 21.98 g of hydroxymethyltriethoxysilane at about 80° C. for a further five hours. The isocyanate can also be added in portions or continuously during the reaction. For isolation of the copolymer, the solvent is stripped off in vacuo, and the residue is freeze-dried. The resultant product has an LCST of about 6° C.

### COMPARATIVE EXAMPLE 1

### Copolymer of N-vinylcaprolactam and hydroxyethyl methacrylate, modified with methyl methacrylate

Comparative Example 1 corresponds to Example 7 of WO 2004/052946.

263.89 g of N-vinylcaprolactam, 12.99 g of hydroxyethyl methacrylate and 8 g of dodecyl mercaptan are dissolved in 500 ml of toluene in a 1 litre three-necked flask fitted with stirrer, reflux condenser and nitrogen feed line, and flushed with nitrogen. 2 g of dibenzoyl peroxide are added, and the mixture is heated at the boiling point of the toluene for 12 h. The copolymer is modified by transesterification with 10.94 g of methyl methacrylate using the transesterification catalyst sodium methoxide and the polymerisation inhibitor hydroquinone monomethyl ether. The methanol formed during the reaction is stripped off here. For isolation of the copolymer, the solvent is stripped off in vacuo, and the residue is freeze-dried. The resultant product has an LCST of about 19° C.

### COATING EXAMPLES

A pearlescent pigment (Iriodin Afflair® 504, manufacturer Merck KGaA, Darmstadt) was used for the following coating experiments.

### COMPARATIVE EXAMPLE 2

For the treatment of Iriodin Afflair® 504 with the LCST polymer of Comparative Example 1, a 0.5% polymer solution is used. The pigment (10% by weight) is dispersed in water for 15 min at 800 rpm. The dispersion is subsequently cooled to a temperature of 5° C. After addition of the polymer solution, the pigment is coated with the polymer at 50° C. for 30 min, and the precipitated polymer is then crosslinked for 3 h. The initiator system used per gram of polymer is 0.8 g of sodium pyrosulfite, 0.4 g of iron(II) sulfate and 0.8 g of potassium peroxodisulfate. The polymer concentration, based on the pigment, was 5% by weight.

### EXAMPLES 8 to 14

### According to the Invention

In a similar manner as described in Comparative Example 1, the pigment Iriodin Afflair® 504 is treated with the LCST polymers obtained in Examples 1 to 7. The crosslinking of the polymer layer is carried out using dibutyltin diacetate as crosslinking catalyst over a period of 3 h.

### Testing Experiments

### EXAMPLE 15

### Testing By Size Exclusion Chromatography

The coated pigments obtained in Comparative Example 1 and Examples 8 to 14 are dispersed in methyl methacrylate with continuous stirring to give a 5% dispersion and heated to 80° C. in a nitrogen atmosphere. A sample is taken from the dispersion after 30, 60 and 90 min, cooled in ice and precipitated in methanol. In addition, the reaction mixtures are measured by means of size exclusion chromatography. The corresponding chromatograms are reproduced in FIGS. 1 and 2.

The chromatogram shown in FIG. 1 was recorded with a sample in which the pigment prepared in Comparative Example 2 had been dispersed in methyl methacrylate. The chromatogram shows that some of the monomer methyl methacrylate has reacted to give polymethyl methacrylate after only 30 min (chromatogram 1), which is evident from the peaks at a retention time of about 10 min, which grow with the reaction time (60 (chromatogram 2) and 90 min (chromatogram 3)). The fact that the methyl methacrylate polymerises is also shown by the precipitate which forms on dropwise addition to methanol. At the same time, further peaks at longer retention times are evident. These can be assigned to the LCST polymer. It can thus be shown that some of the LCST polymer applied to the pigment can be redissolved.

FIG. 2 shows the chromatogram of a sample in which the coated pigment prepared in Example 8 had been dispersed in methyl methacrylate.

The chromatogram shows no high-molecular-weight fraction at 30 min (chromatogram 4). Only monomer is present. Even after a reaction time of 60 (chromatogram 5) and 90 min (chromatogram 6), a measurable fraction of polymer is not present. Neither is a polymer precipitate evident on dropwise addition to methanol. It can furthermore be seen that virtually no polymer is present in the low-molecular-weight region (16-20 min), which means that very little polymer was dissolved from the coated pigment. This was likewise confirmed very impressively by the “testing by dissolution loss”.

### EXAMPLE 16

### Testing By Dissolution Loss

For the testing, the coated pigments from Examples 8 to 14 and Comparative Example 2 were dispersed in toluene and heated under reflux for 1 h. After the pigments had been filtered off, they were additionally dispersed in ethanol and likewise heated under reflux for one hour. After cooling and drying in a vacuum drying cabinet at 50° C., the weight difference was determined. The results are shown in Table 1. It can be seen that the pigments according to the invention have lost significantly less polymer due to dissolution than those with the comparative polymers.

TABLE 1
Amount of polymer dissolved off

| Pigment | Weight difference [%] |
|---|---|
| Comparative Example 2 | −1.6 |
| Example 8 | −0.2 |
| Example 9 | −0.3 |
| Example 10 | −0.3 |
| Example 11 | −0.4 |
| Example 12 | −0.2 |
| Example 13 | −0.1 |
| Example 14 | −0.2 |

1. LCST polymers containing terminal and/or pendant alkoxysilane groups —Si(OR¹)ₓR¹_{y} on the main chain, where R¹ stands for an alkyl radical having 1 to 6 carbon atoms, Y can adopt the values 0, 1 and 2, and furthermore: x+y=3.

2. LCST polymers according to claim 1, where the proportion of alkoxysilane groups, based on the total number of recurring units of the LCST polymer, is between 0.1 and 55 mol %.

3. LCST polymers according to claim 1, obtainable by copolymerisation of:
A. 45.0 to 99.9 mol % of at least one monomer or macromonomer containing the structural unit:
a. N,N-dialkylacrylamide 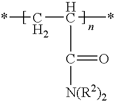
in which n denotes 1 to 10,000 and R² (identical to or different from one another) denotes hydrogen or alkyl groups having 1 to 5 carbon atoms, where the radicals R² may also form a ring together with the nitrogen atom;
b. N-vinylcaprolactam 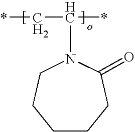
in which o denotes 1 to 10,000;
c. N-vinylpiperidone 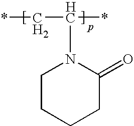
in which p denotes 1 to 10,000;
d. N-vinylpyrrolidone 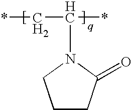
in which q denotes 1 to 10,000;
e. methyl vinyl ether 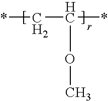
in which r denotes 1 to 10,000;
f. and/or N-vinylalkylamide 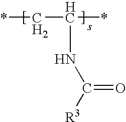
in which s denotes 1 to 10,000 and R³ denotes an (iso)alkyl group having 1 to 5 carbon atoms or a cyclopentyl group;
B. 0 to 55.0 mol % of at least one comonomer from the group of:
a. hydroxyalkyl acrylates or methacrylates in which the hydroxyalkyl group contains 1 to 5 carbon atoms;
b. glycidyl(meth)acrylate;
c. allyl glycidyl ether;
d. α,α-dimethyl-meta-isopropenylbenzyl isocyanate;
e. vinyl isocyanate;
f. isocyanatoethyl(meth)acrylate and/or isocyanatopropyl(meth)acrylate;
g. propenyl isocyanate;
h. primary and secondary acrylamides and methacrylamides;
i. hydroxy- and amino-terminated polyalkylene oxide(meth)acrylates, allyl and vinyl compounds;
C. 0 to 55.0 mol % of at least one comonomer of the formula I: 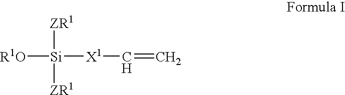
in which:
R¹, each independently, denotes an alkyl radical having 1 to 6 carbon atoms;
X¹ denotes a single bond or an alkylene radical having 1 to 6 carbon atoms;
Z, each independently, denotes an oxygen atom or a single bond;
where comonomers (A), (B) and (C) add up to 100%, and where furthermore, if the LCST polymer contains comonomers B, the polymer obtained by copolymerisation of the monomers or macromonomers (A), (B) and optionally (C) is derivatised by means of a derivatisation agent which contains at least one group which is able to react with a group of a recurring unit emanating from the comonomer (B) with formation of a covalent bond, and at least one alkoxysilane group —Si(OR¹)ₓR¹_{y}, where R¹ stands for an alkyl radical having 1 to 6 carbon atoms, y can adopt the values 0, 1 and 2, and furthermore: x+y=3.

4. LCST polymers according to claim 3, where the derivatisation agent has a structure of the formula II: 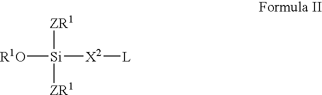
in which:
R¹, each independently, denotes an alkyl radical having 1 to 6 carbon atoms;
X² denotes an alkylene radical having 1 to 6 carbon atoms, a phenylene radical, —(O—(CH₂CHY))ₘ—, where m=1 to 6 and Y═H, CH₃;
Z, each independently, denotes an oxygen atom or a single bond;
L denotes —OH, —NH₂, —SH, —N═C═O, —N═C═S,

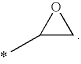

5. LCST polymers according to claim 4, where comonomer (B) is selected from the group (a), (h) and (i), and L in the derivatisation agent of the formula II is selected from —N═C═O, —N═C═S,

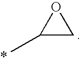

6. LCST polymers according to claim 4, where comonomer (B) is selected from the group (b) to (g), and L in the derivatisation agent of the formula II is selected from —OH, —NH₂ and —SH.

7. Process for the preparation of an LCST polymer according to claim 4, where 45.0 to 99.9 mol % of at least one monomer or macromonomer (A), 0 to 55% by weight of a comonomer (B) and 0 to 55% by weight of a comonomer (C), where (A), (B) and (C) add up to 100%, are subjected to a free-radical polymerisation, and, if the resultant polymer contains comonomers (B), the resultant polymer is derivatised by means of a derivatisation agent which contains at least one group which is able to react with a group of a recurring unit emanating from the comonomer (B) with formation of a covalent bond, and at least one alkoxysilane group —Si(OR¹)ₓR¹_{y}, where R¹, each independently, stands for an alkyl radical having 1 to 6 carbon atoms, y can adopt the values 0, 1 and 2, and furthermore: x+y=3.

8. A method for coating particles or non-particulate substrate surfaces comprising coating with the LCST polymers according to claim 1.

9. A method according to claim 8, where the LCST polymers are brought into contact with the particles or non-particulate substrate surfaces in a liquid medium below the LCST, the temperature is raised to above the LCST, and the polymers are polycondensed on the surface of the particles or on the non-particulate substrate surfaces via the alkoxysilane groups —Si(OR¹)ₓR¹_{y} at this or a higher temperature.

10. A method according to claim 9, where a catalyst is added for the polycondensation.

11. A method according to claim 10, where the catalyst is a protic acid or dibutyltin acetate.

12. Particles or non-particulate substrate surfaces coated with the polymerised LCST polymers according to claim 9.
